(19) United States
(12) Patent Application Publication
(10) Pub. No.: US 2025/0147212 A1
(43) Pub. Date: May 8, 2025

(54) METALENS CAPABLE OF PERFORMING MULTIPLE FUNCTIONS AND APPARATUS FOR DESIGNING THE SAME

(71) Applicant: POSTECH RESEARCH AND BUSINESS DEVELOPMENT FOUNDATION, Pohang-si (KR)

(72) Inventors: Jun Hwa SEONG, Pohang-si (KR); Jun Suk RHO, Pohang-si (KR); Trevon James BADLOE, Pohang-si (KR)

(21) Appl. No.: 18/935,003

(22) Filed: Nov. 1, 2024

(30) Foreign Application Priority Data
Nov. 2, 2023 (KR) 10-2023-0150025
Jul. 18, 2024 (KR) 10-2024-0095132
Oct. 30, 2024 (KR) 10-2024-0151606

(51) Int. Cl. G02B 5/30; B82Y 20/00; G02B 1/00; G02B 27/00

(52) U.S. Cl. CPC G02B 5/3033; B82Y 20/00; G02B 1/002; G02B 27/0012

(57) ABSTRACT

According to an embodiment of present disclosure, there is provided a metalens formed with a plurality of meta-atoms on one surface, including: a first co-polarization channel through which left-handed circular polarization (LCP) incident light exits as left-handed circular polarization (LCP) light, a second co-polarization channel through which right-handed circular polarization (RCP) incident light exits as right-handed circular polarization (RCP) light, a first cross-polarization channel through which left-handed circular polarization (LCP) incident light exits as right-handed circular polarization (RCP) light, and a second cross-polarization channel through which right-handed circular polarization (RCP) incident light exits as left-handed circular polarization (LCP) light, wherein first exit light exiting through the first co-polarization channel and the second co-polarization channel, second exit light exiting through the first cross-polarization channel, and third exit light exiting through the second cross-polarization channel are different in optical characteristics.

### CROSS REFERENCE TO RELATED APPLICATION

Priority to Korean patent application number 10-2023-0150025 filed on Nov. 2, 2023, number 10-2024-0095132 filed on Jul. 18, 2024 and number 10-2024-0151606 filed on Oct. 30, 2024 the entire disclosure of which is incorporated by reference herein, is claimed.

### BACKGROUND OF THE INVENTION

### Field of the Invention

The disclosure relates to a metalens capable of performing multiple functions and an apparatus for designing the same.

### Description of the Related Art

A metalens refracts, reflects and diffracts light using nanoscale meta-atoms formed on the surface thereof.

The metalens can be manufactured in an ultra-thin form because it uses the nanoscale meta-atoms to refract light unlike a conventional optical lens that uses the thickness/curvature thereof to refract light.

Further, the metalens can control exit light more precisely by adjusting the shape/arrangement of each meta-atom because each meta-atom controls the phase of light.

With the foregoing advantages of the metalens, research on the metalens is conducted in various fields.

### Documents of Related Art

(Patent Document 1) Korean Patent Publication No. 10-2023-0148823 (Oct. 25, 2023)

### SUMMARY OF THE INVENTION

Embodiments of the disclosure are conceived to solve the foregoing problems, and are to provide a metalens capable of performing the multiple functions as a single lens and an apparatus for designing the same.

According to the disclosure, there is provided a metalens formed with a plurality of meta-atoms on one surface, including: a first co-polarization channel through which left-handed circular polarization (LCP) incident light exits as left-handed circular polarization (LCP) light, a second co-polarization channel through which right-handed circular polarization (RCP) incident light exits as right-handed circular polarization (RCP) light, a first cross-polarization channel through which left-handed circular polarization (LCP) incident light exits as right-handed circular polarization (RCP) light, and a second cross-polarization channel through which right-handed circular polarization (RCP) incident light exits as left-handed circular polarization (LCP) light, wherein first exit light exiting through the first co-polarization channel and the second co-polarization channel, second exit light exiting through the first cross-polarization channel, and third exit light exiting through the second cross-polarization channel are different in optical characteristics.

Further, the plurality of meta-atoms may include a plurality of nanostructures which has a co-polarization transmission of 40% or more and a cross-polarization transmission of 40% or more.

Further, the plurality of nanostructures may be based on a combination of four rectangular parallelepiped nanostructures with different length and width ratios.

Further, the plurality of meta-atoms may include a plurality of nanostructures having the same phase difference between a co-polarization phase and a cross-polarization phase. The phase difference may be π/4 (rad).

Further, the first exit light may be focused on a first focus formed on an optical axis of the metalens, the second exit light may be focused on a second focus spaced apart from the optical axis to one side; and the third exit light may be focused on a third focus spaced apart from the optical axis to the other side.

Further, the first exit light, the second exit light and the third exit light may be different in orbital angular momentum.

According to an embodiment, there is provided an apparatus for designing a metalens capable of performing multiple functions with a plurality of nanostructures, the apparatus including: a propagation phase design unit configured to control a shape and size of the nanostructure so that light transmitted through the nanostructure can have a specific propagation phase; and a geometric phase design unit configured to design a rotation angle of the nanostructure so that light transmitted through the nanostructure can have a specific geometric phase, wherein the light transmitted through a metasurface is refracted to be focused on a place other than the center of the metasurface or focused to have orbital angular momentum.

Further, the propagation phase design unit may select the plurality of nanostructures with different sizes to have different phases.

Further, the propagation phase design unit may select the plurality of nanostructures having the same phase difference between a co-polarization phase and a cross-polarization phase.

Further, the propagation phase design unit may select the plurality of nanostructures which has a transmission of 40% to 60% in each of a co-polarization channel and a cross-polarization channel.

Further, the propagation phase design unit may be designed to arrange the plurality of nanostructures having the same phase difference between a co-polarization phase and a cross-polarization phase, so that the transmitted light can have a hyperbolic lens phase.

Further, the hyperbolic lens phase may be formed by combining a plurality of propagation phases derived by controlling the shape and size of each of the plurality of nanostructures.

Further, the geometric phase design unit may be designed to rotate the plurality of nanostructures to have a phase in which the transmitted light can be refracted and focused.

Further, the phase in which the light may be refracted and focused is formed by combining a plurality of geometric phases derived by controlling the rotation angles of the plurality of nanostructures.

Further, the geometric phase design unit may be designed to rotate the plurality of nanostructures so that the transmitted light can have a phase with the orbital angular momentum.

Further, the phase with the orbital angular momentum may be formed by combining a plurality of geometric phases derived by controlling the rotation angles of the plurality of nanostructures.

According to an embodiment, there is provided a metalens capable of performing multiple functions, including a plurality of nanostructures having a specific shape, size and rotation angle calculated by the apparatus for designing the metalens capable of performing the multiple functions.

Further, when light passes through the metalens capable of performing the multiple functions, the light may be refracted and focused on a place other than the center of the metalens capable of performing the multiple functions.

Further, when light passes through the metalens capable of performing the multiple functions, the light may be focused to have orbital angular momentum.

Further, light emitted to the metalens capable of performing the multiple functions may have a wavelength of 600 nm to 650 nm.

Further, the nanostructure may be made of hydrogenated amorphous silicon.

### BRIEF DESCRIPTION OF THE DRAWINGS

FIG. 1 is a diagram conceptually showing the configuration of an apparatus for designing metalens capable of performing multiple functions.

FIG. 2 is a diagram conceptually showing the sub-configuration of a processor in the apparatus of FIG. 1 for designing the metalens capable of performing the multiple functions.

FIG. 3 illustrates a metalens capable of performing multiple functions according to an embodiment of the disclosure, including a plurality of nanostructures having a specific shape (e.g., a rectangular parallelepiped), size, and rotation angle, which are calculated by the apparatus of FIG. 1 for designing the metalens capable of performing the multiple functions.

FIG. 4 illustrates a metalens capable of performing multiple functions according to another embodiment of the disclosure, including a plurality of nanostructures having a specific shape (e.g., a rectangular parallelepiped), size, and rotation angle, which are calculated by the apparatus of FIG. 1 for designing the metalens capable of performing the multiple functions.

FIG. 5 illustrates a nanostructure, i.e. a part of a metasurface 10 or 10′ capable of performing the multiple functions, shown in FIGS. 3 and 4, and a unit cell.

FIG. 6 is a graph for designing a plurality of nanostructures different in size, which are executed by a geometric phase design unit.

FIG. 7 is a diagram conceptually showing four different types of nanostructures selected by the geometric phase design unit, and the transmission and phase difference (Δψ) of each nanostructure.

FIG. 8 illustrates a hyperbolic lens phase for designing the metalens of FIG. 3 capable of performing the multiple functions, and a phase in which light is refracted and focused.

FIG. 9 illustrates a hyperbolic lens phase for designing the metalens of FIG. 4 capable of performing the multiple functions, and a phase having orbital angular momentum.

FIG. 10A shows scanning electron microscope (SEM) images of the metalens capable of performing the multiple functions (having a refracting function), FIG. 10B is a diagram conceptually showing a setup for optical measurement experiment, FIG. 10C shows point spread function (PSF) images measured in different channels, and FIG. 10D shows enlarged PSF images of FIG. 10C.

FIG. 11A shows SEM images of the metalens capable of performing the multiple functions, focused to have orbital angular momentum, FIG. 11B is a diagram conceptually showing a setup for optical measurement experiment, FIG. 11C shows PSF images measured in different polarization channels, and FIG. 11D shows PSF images corresponding to polarization channels.

FIG. 12A shows imaging experiment results of the metalens 10 capable of performing the multiple functions (having the refracting function) in which transmitted light is refracted and focused on a place other than the center of the metasurface, FIG. 12B shows imaging experiment results of the metalens 10′ capable of performing the multiple functions, which are focused to have orbital angular momentum, and FIG. 12C is a graph showing the results of analyzing horizontal and vertical 1D cuts.

### DETAILED DESCRIPTION OF THE INVENTION

Below, specific embodiments of the disclosure will be described in detail with reference to the accompanying drawings. In terms of describing the disclosure, detailed descriptions about publicly known configurations or functions incorporated herein will be omitted when they may make the subject matters of the disclosure rather unclear.

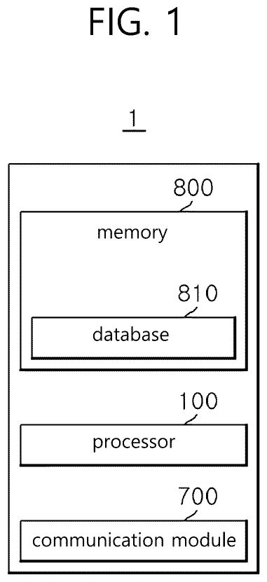

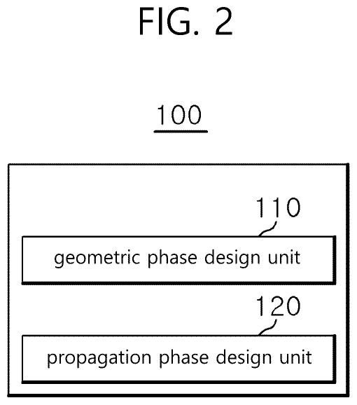

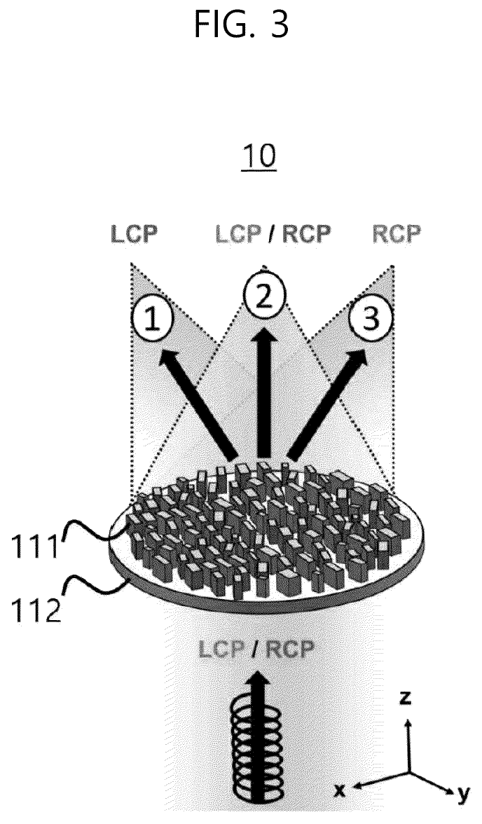

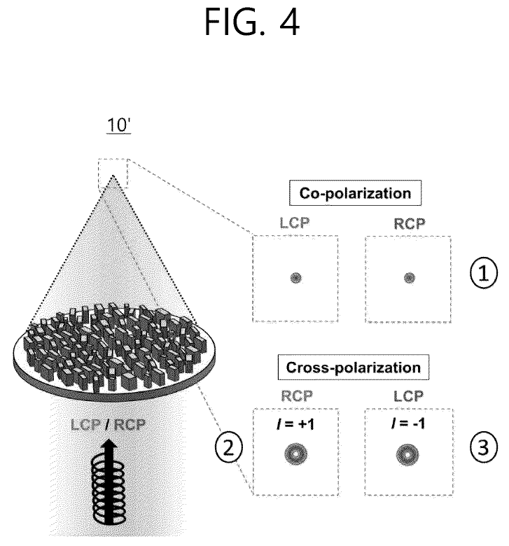

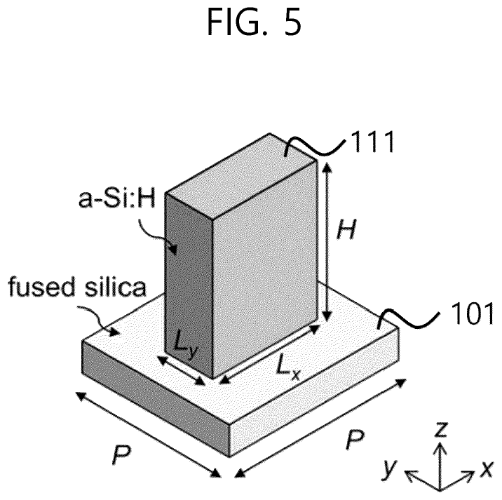

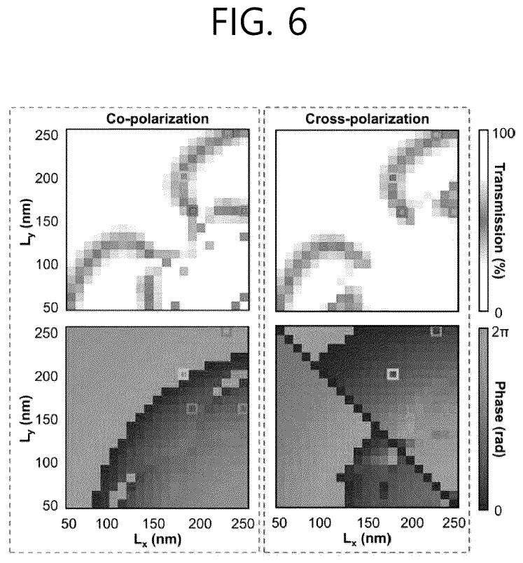

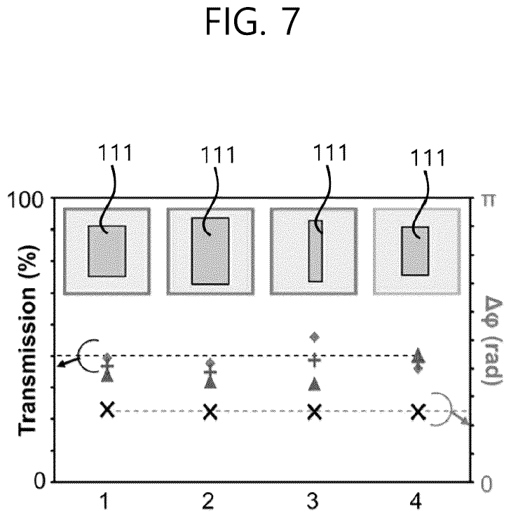

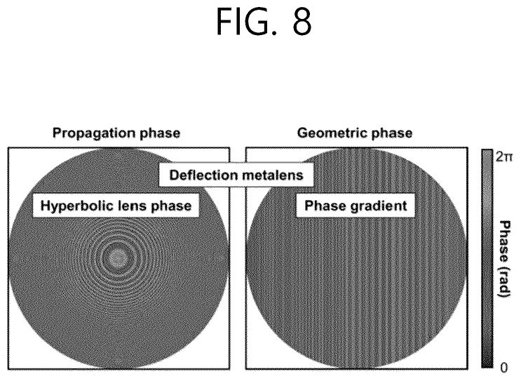

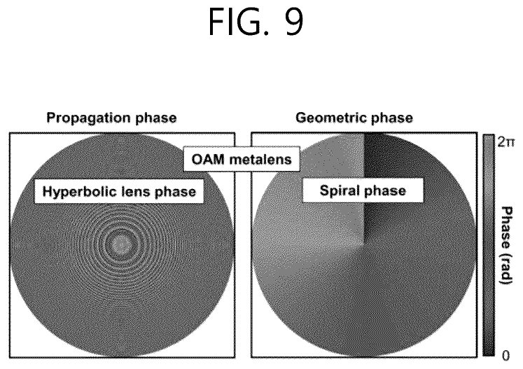

FIG. 1 is a diagram conceptually showing the configuration of an apparatus 1 for designing metalens capable of performing multiple functions, FIG. 2 is a diagram conceptually showing the sub-configuration of a processor 100 in the apparatus 1 of FIG. 1 for designing the metalens capable of performing the multiple functions, FIG. 3 illustrates a metalens 10 capable of performing multiple functions according to an embodiment of the disclosure, including a plurality of nanostructures 111 having a specific shape (e.g., a rectangular parallelepiped), size, and rotation angle, which are calculated by the apparatus 1 of FIG. 1 for designing the metalens capable of performing the multiple functions, FIG. 4 illustrates a metalens 10′ capable of performing multiple functions according to another embodiment of the disclosure, including a plurality of nanostructures 111 having a specific shape (e. g., a rectangular parallelepiped), size, and rotation angle, which are calculated by the apparatus 1 of FIG. 1 for designing the metalens capable of performing the multiple functions, FIG. 5 illustrates a nanostructure 111, i.e. a part of a metasurface 10 or 10′ capable of performing the multiple functions, shown in FIGS. 3 and 4, and a unit cell 101, FIG. 6 is a graph for designing a plurality of nanostructures 111 different in size, which are executed by a geometric phase design unit 110, FIG. 7 is a diagram conceptually showing four different types of nanostructures 111 selected by the geometric phase design unit 110, and the transmission and phase difference (Δψ) of each nanostructure 111, FIG. 8 illustrates a hyperbolic lens phase for designing the metalens 10 of FIG. 3 capable of performing the multiple functions, and a phase in which light is refracted and focused, and FIG. 9 illustrates a hyperbolic lens phase for designing the metalens 10′ of FIG. 4 capable of performing the multiple functions, and a phase having orbital angular momentum.

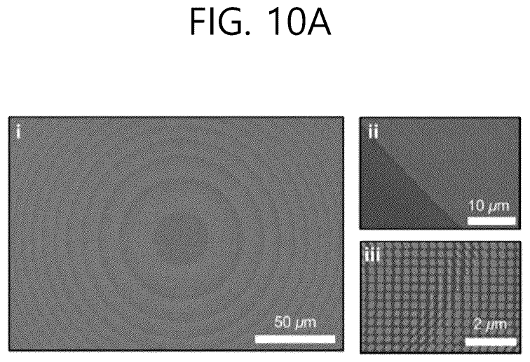

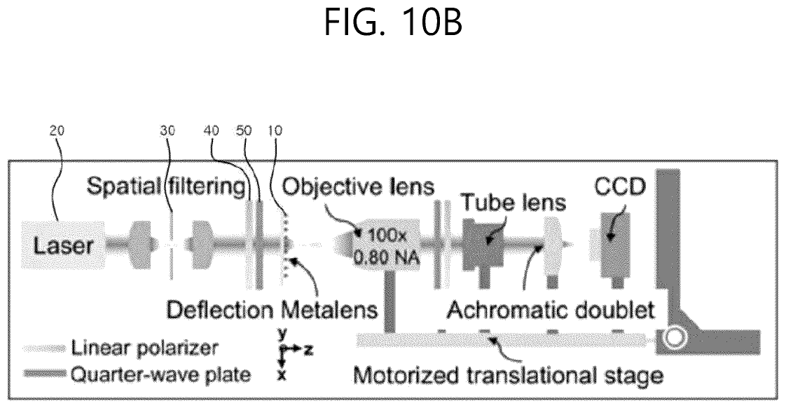

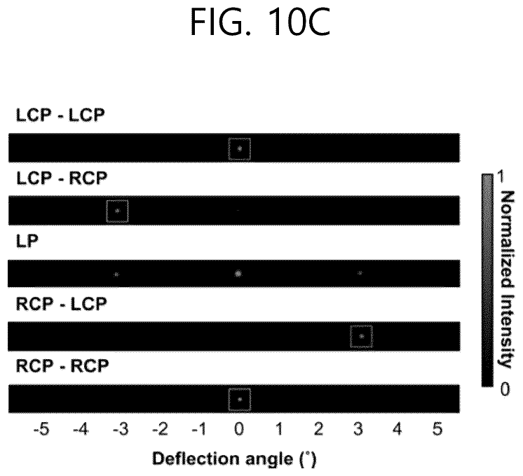

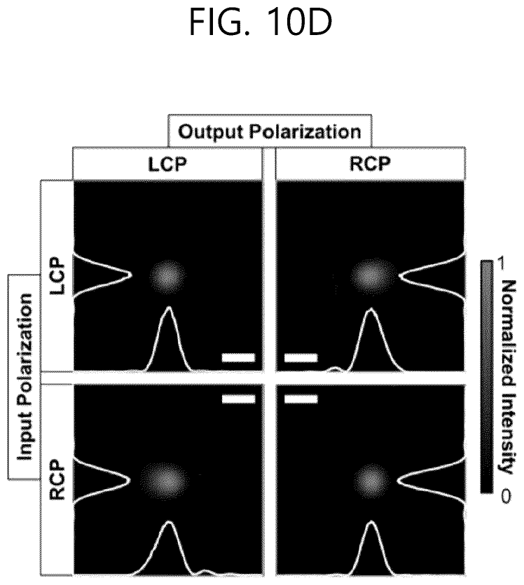

Further, FIG. 10A shows a scanning electron microscope (SEM) image of the metalens capable of performing the multiple functions (having a refracting function), FIG. 10B is a diagram conceptually showing a setup for optical measurement experiment, FIG. 10C shows point spread function (PSF) images measured in different channels, and FIG. 10D shows enlarged PSF images of FIG. 10C.

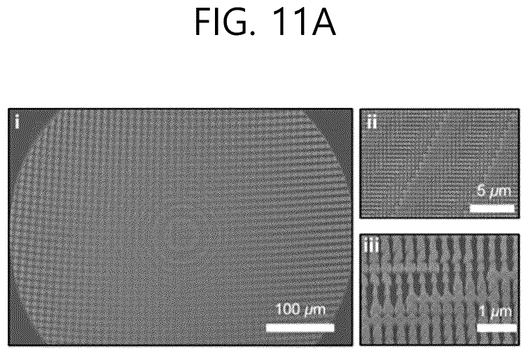

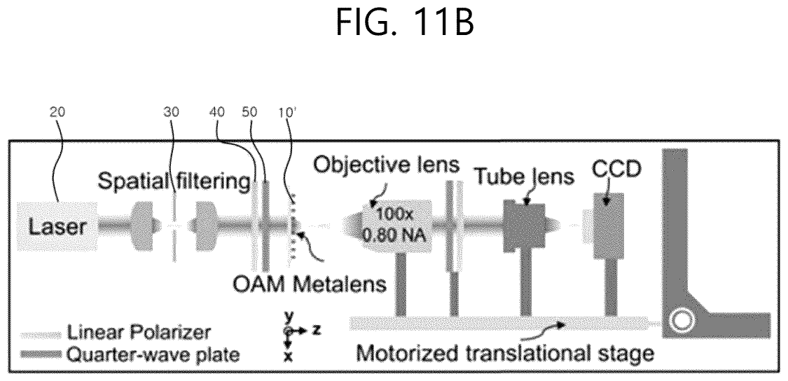

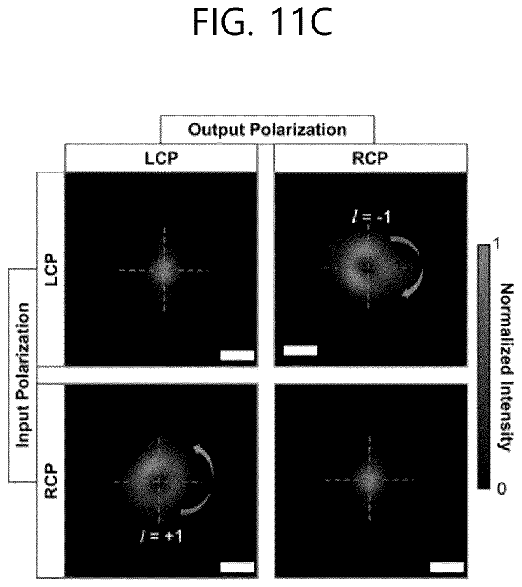

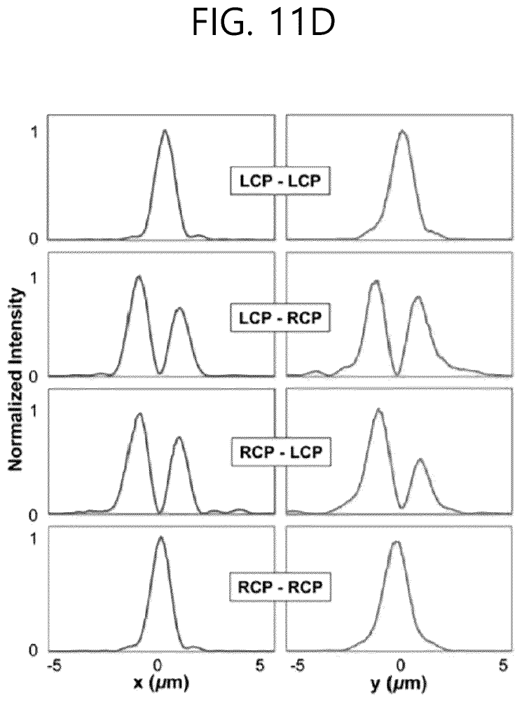

FIG. 11A shows SEM images of the metalens capable of performing the multiple functions, focused to have orbital angular momentum, FIG. 11B is a diagram conceptually showing a setup for optical measurement experiment, FIG. 11C shows PSF images measured in different polarization channels, and FIG. 11D shows PSF images corresponding to polarization channels.

Referring to FIGS. 1 to 11, the apparatus 1 for designing the metalens capable of performing the multiple functions may design the metalens 10 capable of performing the multiple functions, in which transmitted light is refracted and focused at different positions (see FIG. 3), and the metalens 10′ capable of performing the multiple functions, in which transmitted light is focused in spiral forms different in orbital angular momentum (see FIG. 4).

As shown in FIG. 3, the metalens 10 capable of performing the multiple functions according to an embodiment of the disclosure may function as a standard metalens to focus the transmitted light, and make the transmitted light be refracted according to polarization characteristics of incident light and focused at different positions. For example, the metalens 10 forms a first focus on an optical axis, through which first exit light passes; a second focus spaced apart from the optical axis to one side, through which second exit light passes; and a third focus spaced apart from the optical axis to the other side, through which third exit light passes.

Here, it may be understood that the standard metalens functions to make the transmitted light have a hyperbolic lens phase as shown in FIGS. 8 and 9.

In this embodiment, the metalens may be understood as a lens that includes a plurality of nanostructures 111 having a nanoscale size (e.g., a length Lx of 150 nm to 250 nm, and a width Ly of 50 nm to 150 nm), so that light passed through the nanostructures 111 designed to have specific structures (size, shape, rotation angle, etc.) can be focused.

As shown in FIG. 4, the metalens 10′ capable of performing the multiple functions according to another embodiment of the disclosure may function as a standard metalens to focus the transmitted light, and make exit light be different in orbital angular momentum. For example, the first exit light, the second exit light and the third exit light may be different in the orbital angular momentum from one another.

The metalens 10 of FIG. 3 capable of performing the multiple functions has two functions (as a standard metalens, and a metalens for focusing based on refraction), and the metalens 10′ of FIG. 4 capable of performing the multiple functions has two functions (as a standard metalens, and a metalens for focusing to have orbital angular momentum).

In this embodiment, the apparatus 1 for designing the metalens capable of performing the multiple functions may include a memory 800, a processor 100, and a communication module 700 (see FIGS. 1 and 2).

The processor 100 may be configured to perform basic arithmetic, logic, and input/output operations to process instructions of a computer program. The instructions may be provided from the memory 800 or the communication module 700 to the processor 100.

In the apparatus 1 for designing the metalens capable of performing the multiple functions, the processor 100 may be configured to implement various functions such as data input/output, data processing, data management, and communication based on a communication network, which are needed to design the metalens 10 capable of performing the multiple functions, which functions as the standard metalens to focus the transmitted light and refract the transmitted light to be focused on a place other than the center; and the metalens 10′ capable of performing the multiple functions, which functions as the standard metalens to focus the transmitted light and performs focusing to have orbital angular momentum. Specific components of the processor 100 configured to implement such functions will be described later.

Further, at least some components of the processor 100 may include an artificial neural network trained in advance by machine learning. Further, the memory 800 may refer to a computer readable recording medium that includes a random-access memory (RAM), a read only memory (ROM), a disk drive, and a permanent mass storage device such as a disk drive.

In the apparatus 1 for designing the metalens capable of performing the multiple functions according to this embodiment, the processor 100 may include a geometric phase design unit 110, and a propagation phase design unit 120.

The propagation phase design unit 120 may control the shape and size of the nanostructure 111 so that light transmitted through the nanostructure 111 can have a specific propagation phase.

The geometric phase design unit 110 may design the rotation angle of the nanostructure 111 so that light transmitted through the nanostructure 111 can have a specific geometric phase.

Here, the control to have the specific propagation phase may be understood as control for the phase accumulation of light when the light passes through the nanostructure 111, and the design to have the specific geometric phase may be understood as control for sensitivity to spin angular momentum (SAM) or sensitivity to circular polarization in connection with the in-plane orientation of the anisotropic nanostructure 111.

The propagation phase design unit 120 may select a plurality of nanostructures 111 different in size from one another to design different phases. To cover the entire 2π space, the plurality of nanostructures 111 may be selected to have different co-polarization phases and be evenly distributed from 0 to 2π (rad) or from 0 to π (rad). Further, the plurality of nanostructures 111 may be selected to have different cross-polarization phases and be evenly distributed from 0 to 2π (rad) or from 0 to π (rad).

The propagation phase design unit 120 may select the nanostructures 111 different in size but having the same phase difference (Δψ) in a co-polarization channel and a cross-polarization channel. In other words, all the selected nanostructures 111 may have the same phase difference between a co-polarization phase and a cross-polarization phase. For example, the nanostructures 111 shaped in which the phase difference between the co-polarization phase and the cross-polarization phase is π/4 may be selected.

Further, the propagation phase design unit 120 may select a plurality of nanostructures 111 shaped to have a co-polarization transmission of 40% or more and a cross-polarization transmission of 40% or more. Preferably, the propagation phase design unit 120 may select a plurality of nanostructures 111 shaped to have a co-polarization transmission of 40% to 60% and a cross-polarization transmission of 40% to 60%. The co-polarization transmission may refer to the transmission of the co-polarization channel, and the cross-polarization transmission may refer to the transmission of the transmission of the cross-polarization channel. For example, the propagation phase design unit 120 may select four nanostructures 111 having a rectangular parallelepiped shape as shown in the following [Table 1].

TABLE 1

| Meta- | | | Co-pol | Co-pol | Cross-pol | Cross-pol |
|---|---|---|---|---|---|---|
| atom | Length | Width | phase | transmission | phase | transmission |
| # | (nm) | (nm) | (2π rad) | (%) | (2π rad) | (%) |
| 1 | 190 | 140 | 0.26 | 49 | 0.01 | 44 |
| 2 | 250 | 140 | 0.37 | 48 | 0.12 | 42 |
| 3 | 230 | 50 | 0.85 | 56 | 0.60 | 41 |
| 4 | 180 | 100 | 0.98 | 46 | 0.73 | 50 |

All four nanostructures 111 have the same height (thickness) of about 500 nm, and the four nanostructures 111 may be formed on a unit cell 101 (refer to FIG. 5) having a thickness of about 350 nm.

Referring to [Table 1], all four nanostructures 111 have a phase difference of 0.25 rad between the co-polarization phase (or co-pol phase) and the cross-polarization phase (or cross-pol phase).

Further, referring to [Table 1], all the four nanostructures 111 has a co-polarization transmission (or co-pol transmission) of 40% to 60% and a cross-polarization transmission (or cross-pol transmission) of 40% to 60%.

Alternatively, the propagation phase design unit 120 may select a plurality of nanostructures 111 (e.g., four nanostructures 111) different in size and having a rectangular parallelepiped shape, of which the length Lx ranges from 150 nm to 250 nm and the width Ly ranges from 150 nm to 250 nm.

For example, referring to the bottom of the FIG. 6, the propagation phase design unit 120 may select the nanostructure 111 having a length Lx of 250 nm and a width Ly of 160 nm (see the part marked in light blue in FIG. 6), the nanostructure 111 having a length Lx of 180 nm and a width Ly of 160 nm (see the part marked in red in FIG. 6), the nanostructure 111 having a length Lx of 170 nm and a width Ly of 200 nm (see the part marked in purple in FIG. 6), and the nanostructure 111 having a length Lx of 235 nm and a width Ly of 245 nm (see the part marked in yellow in FIG. 6). Here, the height (H) may not be a variable that affects the phase, but the nanostructures 111 may have the same height (H) of, for example, 450 nm to 550 nm, preferably, 500 nm.

According to an embodiment of the disclosure, the metalens 10 uses the four nanostructures 111 having a co-polarization transmission (co-pol transmission) of 40% to 60% and a cross-polarization transmission (cross-pol transmission) of 40% to 60%, thereby forming the co-polarization channel and the cross-polarization channel.

Here, the co-polarization channel may include a first co-polarization channel in which left-handed circular polarization (LCP) incident light exits as LCP light, and a second co-polarization channel in which right-handed circular polarization (RCP) incident light exits as RCP light.

Further, the cross-polarization channel may include a first cross-polarization channel in which LCP incident light exits as RCP light, and a second cross-polarization channel in which RCP incident light exits as LCP light.

According to an embodiment of the disclosure, the metalens 10 is designed to make the first exit light exiting the first co-polarization channel and the second co-polarization channel, the second exit light exiting the first cross-polarization channel, and the third exit light exiting the second cross-polarization channel be different in optical characteristics from one another, thereby performing the multiple functions.

FIG. 7 conceptually shows four different types of nanostructures 111 selected by the geometric phase design unit 120, and the transmission and phase difference (Δψ) of each nanostructure.

Referring to FIG. 7, the black X represents the phase of light when passed through the corresponding nanostructure (positioned above), the blue diamond represents the transmission of light when transmitted to the co- polarization channel designed to have the corresponding nanostructure, the red triangle represents the transmission of light when transmitted to the cross-polarization channel designed to have the corresponding nanostructure, and the green cross represents average transmission the co-polarization channel and the cross-polarization channel designed to have the corresponding nanostructure.

The propagation phase design unit 120 may arrange the plurality of nanostructures 111 having a phase difference of π/4 so that the transmitted light can have the hyperbolic lens phase.

Here, the hyperbolic lens phase may be derived by controlling the shape and size of the plurality of nanostructures 111 to control each propagation phase of the transmitted light.

Further, the hyperbolic lens phase refers to a phase that a hyperbolic lens phase plate has as shown on the left in FIG. 8, and may be understood as a phase derived by combining a plurality of propagation phases by the plurality of nanostructures 111.

In addition, the geometric phase design unit 110 may rotate the plurality of nanostructures 111 having a phase difference of π/4 so that the transmitted light can be refracted and focused to have a phase gradient.

Here, the phase in which the light is refracted and focused may be derived by controlling the rotation angle of the nanostructure 111.

Further, the phase in which the light is refracted and focused refers to a phase that a specific phase plate has as shown on the right in FIG. 8, and may be understood as a phase derived by combining a plurality of geometric phases by the rotation of the plurality of nanostructures 111.

The left in FIG. 8 shows the hyperbolic lens phase derived by controlling the propagation phase of the nanostructures 111, and the right in FIG. 8 shows the phase (or phase gradient) in which the light derived by controlling the geometric phase of the nanostructure 111 is refracted and focused.

The hyperbolic lens phase may be derived by controlling the shapes and sizes of the plurality of nanostructures (e.g., four nanostructures) 111 designed by the propagation phase design unit 120, and the phase in which the light is refracted and focused may be derived by controlling the rotation angle of the nanostructure 111 having the hyperbolic lens phase by the geometric phase design unit 110.

In this way, the apparatus 1 for designing the metalens capable of performing the multiple functions may be configured to design at least one of the shapes, sizes, spaces, and rotation angles of the plurality of nanostructures 111 so that the light transmitted through the co-polarization channel can have the hyperbolic lens phase (see the left in FIG. 8), and the light transmitted through the cross-polarization channel can have the phase in which the light is refracted and focused (see the right in FIG. 8).

As the nanostructures 111 designed by the apparatus 1 for designing the metalens capable of performing the multiple functions are actually manufactured, the metalens 10 shown in FIG. 3 capable of performing the multiple functions may be derived.

The geometric phase design unit 110 may rotate the plurality of nanostructures 111 having a phase difference of π/4 so that the transmitted light can have the phase having the orbital angular momentum.

Here, the phase having the orbital angular momentum may be derived by controlling the rotation angle of the nanostructure 111.

The left in FIG. 9 shows the hyperbolic lens phase derived by controlling the propagation phase of the nanostructures 111, and the right in FIG. 9 shows a phase (or a spiral phase) having the orbital angular momentum derived by controlling the geometric phase of the nanostructure 111.

The hyperbolic lens phase may be derived by controlling the shapes and sizes of the plurality of nanostructures (e.g., four nanostructures) 111 designed by the geometric phase design unit 110, and the phase having the orbital angular momentum may be derived by controlling the rotation angle of the nanostructure 111.

Here, the phase having the orbital angular momentum may be generated by combining a plurality of geometric phases derived by controlling the rotation angles of the plurality of nanostructures 111.

In this way, the apparatus-for designing the metalens capable of performing the multiple functions may be configured to design at least one of the shapes, sizes, spaces, and rotation angles of the plurality of nanostructures 111 so that the light transmitted through the co-polarization channel can have the hyperbolic lens phase (see the left in FIG. 9), and the light transmitted through the cross-polarization channel can have the phase with the orbital angular momentum (see the right in FIG. 9).

As the nanostructures 111 designed by the apparatus 1 for designing the metalens capable of performing the multiple functions are manufactured, the metalens 10′ shown in FIG. 4 capable of performing the multiple functions may be derived.

Below, the metasurface 10 or 10′ capable of performing the multiple function, which includes the nanostructures 111 of which the specific shapes, sizes and rotation angles calculated by the foregoing apparatus 1 for designing the metalens capable of performing the multiple functions, will be described in more detail.

The metasurface 10 or 10′ capable of performing the multiple functions may include a plurality of nanostructures 111, and a substrate 112.

The substrate 112 may include a plurality of unit cells 101, and one nanostructure 111 may be placed on each unit cell 101. A single unit cell 101 and a single nanostructure 111 may be defined as a single meta-atom.

Each nanostructure 111 may be formed in a rectangular parallelepiped shape having a length Lx, a width Ly and a height H.

Each nanostructure 111 may be made of hydrogenated amorphous silicon (a-Si:H) with a low loss rate, and each unit cell 101 may be made of fused silica, i.e., silicon dioxide.

Further, the nanostructures 111 may be arranged at regular intervals P.

Further, light emitted to the metasurface capable of performing the multiple functions may have a wavelength range (for example, 600 nm to 650 nm, preferably 630 nm) of visible light.

In this embodiment, the metasurface capable of performing the multiple functions not only serves as the general metalens, but also performs focusing with orientations or focusing in spiral forms with orbital angular momentum according to polarization controls. The technology of manufacturing the metalens capable of these functions may be utilized in the fields of chiral bioimaging and optical computing.

Further, a single metalens may perform three functions based on new design methodology using both the propagation phase and the geometric phase.

According to this embodiment, the single metalens can have multiple functions, thereby ensuring that optical components are miniaturized with a high degree of integration.

Further, to implement the multiple functions by the single metalens, the propagation phase is used in providing the hyperbolic lens phase (co-polarization channel, LCP-LCP, and RCP-RCP), and the geometric phase is used in providing an additional polarization selection mode (cross- polarization channel, LCP-RCP, and RCP-LCP).

Two metalens (i.e., the metalens 10 capable of performing the multiple functions, and the metalens 10′ capable of performing the multiple functions) may be manufactured based on variables (e.g., shapes, sizes, periods, rotation angles) designed by the apparatus 1 for designing the metalens capable of performing the multiple functions.

In the metalens 10 capable of performing the multiple functions, the co-polarization channel having the plurality of nanostructures 111 may implement the functions of the standard metalens, and the cross-polarization channel may refract the transmitted light to be focused at different left and right positions.

Further, in the metalens 10′ capable of performing the multiple functions, the co-polarization channel having the plurality of nanostructures 111 may implement the functions of the standard metalens, and the cross- polarization channel may provide the orbital angular momentum to perform the function of the spiral lens having a topological charge of 1=±1.

In this embodiment, the metasurface capable of performing the multiple functions may use a material (a-Si:H) having a low loss rate to operate in the wavelength range of the visible light, and may operate with respect to light having a wavelength of 633 nm.

Further, the propagation phase and the geometric phase may be used to operate in the co-polarization channel and the cross-polarization channel, respectively.

Further, four types of nanostructures (i.e., meta-atoms) 111 different in size may be selected and designed to be all used in an appropriate transmission range of 40% to 60% (to have a transmission of 40% to 60% in each of the co-polarization channel and the cross-polarization channel).

These four types of nanostructures 111 different in size from one another may be selected to cover the phase of the 2π space.

Here, the co-polarization channel may provide the hyperbolic lens phase to operate like a general metalens, and the cross-polarization channel may refract and focus light to suit the purpose (phase gradient) or provide the phase having the orbital angular momentum, thereby providing a total of two metasurfaces capable of performing the multiple functions. Here, the metasurface may also be called the metalens.

FIG. 10A shows SEM images of the metalens 10 capable of performing the multiple functions (having a refracting function), in which the transmitted light is refracted and focused on a position other than the center of the metasurface, FIG. 10B is a diagram conceptually showing a device for optical measurement experiment, FIG. 10C shows PSF images measured in different channels, respectively, and FIG. 10D shows enlarged PSF images of FIG. 10C.

FIGS. 10A to 10D are diagrams showing verification after manufacturing the foregoing metalens 10 capable of performing the multiple functions.

In FIG. 10B, the optical measurement experiment device according to an embodiment of the disclosure may include the foregoing metalens 10 capable of performing the multiple functions; a light source 20 emitting light having a wavelength of 600 nm to 650 nm (preferably 633 nm) to the metalens 10 capable of performing the multiple functions; a space filtering setup 30 placed in front of the light source 20; and a polarization plate 40 and a quarter-wave plate 50 placed between the metalens 10 and the space filtering setup 30.

Here, the space filtering setup 30 may be understood as a device for generating the Gaussian beam (e.g., Thorlabs, AC127-019-A, Thorlabs, P10CB), the polarization plate 40 may be a linear polarizer (Thorlabs LPVISE050-A), and the quarter-wave plate 50 may be Thorlabs AQWP05M-600.

The light emitted from the light source 20 has a specific polarization state while passing through the space filtering setup 30, the polarization plate 40 and the quarter-wave plate 50, and is then transmitted through the metalens 10 capable of performing the multiple functions.

Incident light is focused by the metalens 10 capable of performing the multiple functions, and collected by a commercial objective lens (Olympus, LMPLFLN 100X). The analyzer (Thorlabs, TTL180-A) may be placed between the objective lens and a tube lens. Further, a charge coupled device (CCD) camera (Lumenera, INFINITY2-1RC) may capture the focus.

In FIG. 10A, i is a photograph showing the center of the metalens 10 capable of performing the multiple functions, which has a diameter of 500 μm, ii is an edge image, and iii is an enlarged image showing the rotated nanostructure 111.

FIG. 10C is a diagram showing a PSF image of the metalens 10 capable of performing the multiple functions under different circular (LCP/RCP) and linear (LP) polarized incident light.

Referring to FIGS. 10A to 10D, after manufacturing the metalens 10 capable of performing the multiple functions, designed based on the selected nanostructure 111, the focuses corresponding to the incident and transmitted polarization channels were measured using the optical measurement setup, and it was confirmed that the measured focuses followed the theoretical PSF.

FIG. 11A is a SEM image of the metalens 10′ capable of performing the multiple functions, focused to have orbital angular momentum, FIG. 11B is a diagram conceptually showing a device for optical measurement experiment, FIG. 11C is a PSF image measured in different polarization channels, and FIG. 11D shows a PSF image for each polarization channel. The device for the optical measurement experiment in FIG. 11B is the same as that of FIG. 10B, and thus repetitive descriptions thereof will be avoided.

Referring to FIGS. 11A to 11D, after actually manufacturing the metalens 10′ capable of performing the multiple functions, having the orbital angular momentum function (Topological Charge=±1), experimental verification was performed. After manufacturing the metalens 10′ capable of performing the multiple functions, designed based on the selected nanostructure 111, the focuses corresponding to the incident and transmitted polarization channels were measured using the optical measurement setup, and it was confirmed that the measured focuses followed a donut-shaped circular PSF like the theoretical PSF.

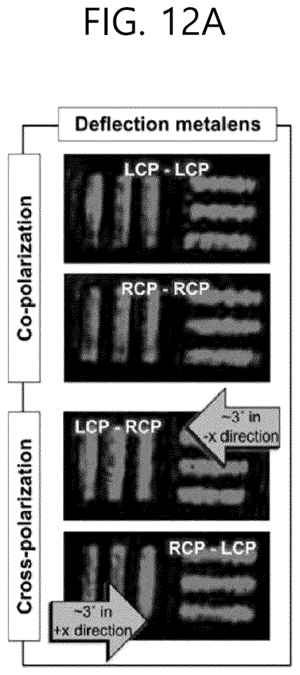

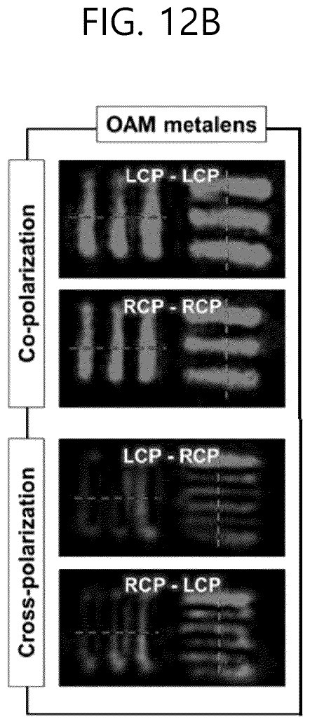

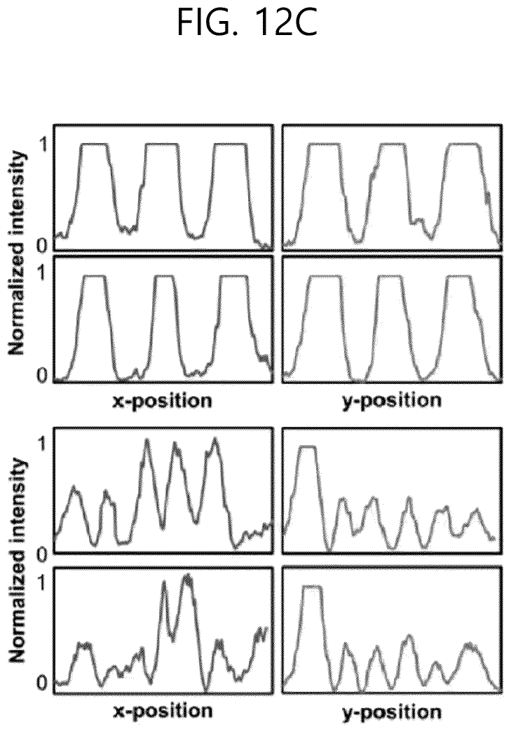

FIG. 12A shows imaging experiment results of the metalens 10 capable of performing the multiple functions (having the refracting function) in which transmitted light is refracted and focused on a place other than the center of the metasurface, FIG. 12B shows imaging experiment results of the metalens 10′ capable of performing the multiple functions, which are focused to have orbital angular momentum, and FIG. 12C is a graph showing the results of analyzing horizontal and vertical 1D cuts.

Referring to FIGS. 12A to 12C, the performance of the lens was verified by performing the imaging experiments on the metalens having each performance. As results of intended imaging experiment, it was confirmed that the metalens 10 having the refracting function forms target images around ±3 degrees. In the metalens 10′ capable of performing the multiple functions, a spiral wavefront is formed at the focus, and thus only an edge portion is observable when an actual target image is measured. As can be seen from the experiment results, it can be also confirmed that only the target image of the edge portion excluding a central portion is formed.

The disclosure provides a method of designing a metasurface capable of performing multiple functions. According to this embodiment, the design method is based on the propagation phase and the geometric phase, and experimentally verified, thereby allowing the metalens to have the multiple functions. Accordingly, the metalens capable of performing different functions according to incident and transmitted polarization channels is utilizable in the fields of multi-channel metalens, chiral bioimaging, optical computing, and computer vision.

The metalens according to this embodiment is utilizable in an optical system including a lens, in particular, any field that requires miniaturization, such as a camera and a microscope, because it can replace the existing lenses, have a thickness of less than 1 μm, and perform various functions. The functions of the metalens may be used in chiral bioimaging, optical computing, computer vision, and the like optical networks.

Further, the metalens according to this embodiment is utilizable in a multi-channel metalens using different incident and transmitted polarization, an anti-tempering optical device operable only under specific polarized states, chiral bioimaging based on polarization channels, and the like cameras or microscopes with multi-functions or the existing lens system.

Further, the metalens according to this embodiment can selectively perform various functions, such as refracting light to be focused, and imaging only an edge portion of a specific object, and be thus applied to various fields such as VR/AR displays, cameras, microscopes, and bioimaging.

According to an embodiment of the disclosure, there are provided a metalens capable of performing multiple functions as a single lens, and an apparatus for designing the same.

When light is transmitted through the metalens capable of performing the multiple functions according to an embodiment of the disclosure, the co-polarization channel may provide the functions of the standard metalens, and the cross-polarization channel may refract the light to be focused on a place other than the center. Further, when light is transmitted through the metalens capable of performing the multiple functions according to another embodiment of the disclosure, the co-polarization channel provides the functions of the standard metalens, and the cross- polarization channel may perform focusing to have the orbital angular momentum.

Although a metalens capable of performing multiple functions and an apparatus for designing the same have been described above as specific embodiments of the disclosure, these embodiments are merely examples and the disclosure is not limited thereto. The disclosure should be construed as having the widest range in accordance with the basic idea disclosed herein. Those skilled in the art may combine or substitute the embodiments of the disclosure to implement the embodiments that are not specified, without departing from the scope of the disclosure. In addition, those skilled in the art may easily change or modify the embodiments based on the present specification, and it is obvious that such changes or modifications also fall within the scope of the disclosure.

What is claimed is:

1. A metalens formed with a plurality of meta-atoms on one surface, comprising:
a first co-polarization channel through which left-handed circular polarization (LCP) incident light exits as left-handed circular polarization (LCP) light,
a second co-polarization channel through which right-handed circular polarization (RCP) incident light exits as right-handed circular polarization (RCP) light,
a first cross-polarization channel through which left-handed circular polarization (LCP) incident light exits as right-handed circular polarization (RCP) light, and
a second cross-polarization channel through which right-handed circular polarization (RCP) incident light exits as left-handed circular polarization (LCP) light,
wherein first exit light exiting through the first co-polarization channel and the second co-polarization channel, second exit light exiting through the first cross-polarization channel, and third exit light exiting through the second cross-polarization channel are different in optical characteristics.

2. The metalens of claim 1, wherein the plurality of meta-atoms comprises a plurality of nanostructures which has a co-polarization transmission of 40% or more and a cross-polarization transmission of 40% or more.

3. The metalens of claim 2, wherein the plurality of nanostructures is based on a combination of four rectangular parallelepiped nanostructures with different length and width ratios.

4. The metalens of claim 1, wherein the plurality of meta-atoms comprises a plurality of nanostructures having the same phase difference between a co-polarization phase and a cross-polarization phase.

5. The metalens of claim 4, wherein the phase difference is π/4 (rad).

6. The metalens of claim 1, wherein:
the first exit light is focused on a first focus formed on an optical axis of the metalens,
the second exit light is focused on a second focus spaced apart from the optical axis to one side; and
the third exit light is focused on a third focus spaced apart from the optical axis to the other side.

7. The metalens of claim 1, wherein the first exit light, the second exit light and the third exit light are different in orbital angular momentum.

8. An apparatus for designing a metalens capable of performing multiple functions with a plurality of nanostructures, the apparatus comprising:
a propagation phase design unit configured to control a shape and size of the nanostructure so that light transmitted through the nanostructure can have a specific propagation phase; and
a geometric phase design unit configured to design a rotation angle of the nanostructure so that light transmitted through the nanostructure can have a specific geometric phase,
wherein the light transmitted through a metasurface is refracted to be focused on a place other than the center of the metasurface or focused to have orbital angular momentum.

9. The apparatus of claim 8, wherein the propagation phase design unit selects the plurality of nanostructures with different sizes to have different phases.

10. The apparatus of claim 9, wherein the propagation phase design unit selects the plurality of nanostructures in which a co-polarization phase and a cross-polarization phase have the same phase difference.

11. The apparatus of claim 8, wherein the propagation phase design unit selects the plurality of nanostructures which has a transmission of 40% to 60% in each of a co-polarization channel and a cross-polarization channel.

12. The apparatus of claim 8, wherein the propagation phase design unit is designed to arrange the plurality of nanostructures so that the transmitted light can have a hyperbolic lens phase.

13. The apparatus of claim 12, wherein the hyperbolic lens phase is formed by combining a plurality of propagation phases derived by controlling the shape and size of each of the plurality of nanostructures.

14. The apparatus of claim 8, wherein the geometric phase design unit is designed to rotate the plurality of nanostructures to have a phase in which the transmitted light can be refracted and focused.

15. The apparatus of claim 14, wherein the phase in which the light is refracted and focused is formed by combining a plurality of geometric phases derived by controlling the rotation angles of the plurality of nanostructures.

16. The apparatus of claim 8, wherein the geometric phase design unit is designed to rotate the plurality of nanostructures so that the transmitted light can have a phase with the orbital angular momentum.

17. The apparatus of claim 8, wherein the phase with the orbital angular momentum is formed by combining a plurality of geometric phases derived by controlling the rotation angles of the plurality of nanostructures.

18. A metalens capable of performing multiple functions, comprising a plurality of nanostructures having a specific shape, size and rotation angle calculated by the apparatus of claim 8 for designing the metalens capable of performing the multiple functions.
